(19) United States
(12) Patent Application Publication
(10) Pub. No.: US 2025/0327988 A1
(43) Pub. Date: Oct. 23, 2025

(54) STRUCTURE AND METHOD FOR TEMPERATURE-BASED FOCUSING OF LONG-FOCAL-LENGTH CAMERA

(71) Applicant: XI'AN INSTITUTE OF OPTICS AND PRECISION MECHANICS, CHINESE ACADEMY OF SCIENCES, Xi'an, Shaanxi (CN)

(72) Inventors: Jian ZHANG, Xi'an, Shaanxi (CN); Guorui REN, Xi'an, Shaanxi (CN); Gangyi ZOU, Xi'an, Shaanxi (CN); Zhe XU, Xi'an, Shaanxi (CN)

(21) Appl. No.: 18/867,544

(22) PCT Filed: Dec. 7, 2023
(86) PCT No.: PCT/CN2023/136941

§ 371 Date: Nov. 20, 2024

(30) Foreign Application Priority Data
Dec. 7, 2022 (CN) 202211565511.9

(51) Int. Cl. G02B 7/198; G03B 13/32

(52) U.S. Cl. CPC G02B 7/198; G03B 13/32

(57) ABSTRACT

A structure for temperature-based focusing of a long-focal-length camera includes a thermal ring, a thermal insulation pad, a secondary lens mount outer frame, and a primary lens support. An outer side face of the thermal ring is provided with a temperature control device and a temperature measuring device. The other end of the secondary lens mount outer frame is driven to expand or contract by thermal expansion and contraction of the thermal ring along the radial direction. A secondary lens piece is arranged at the central axis of one end of the secondary lens mount outer frame far away from the thermal insulation pad. A plurality of secondary lens mount spokes are uniformly arranged on the secondary lens piece along the circumferential direction; one end of the primary lens support far away from the secondary lens mount outer frame is provided with a primary lens piece.

### TECHNICAL FIELD

The present disclosure relates to a structure and method for focusing a camera, particularly to a structure and method for temperature-based focusing of a long-focal-length camera.

### BACKGROUND OF THE INVENTION

During the use of general long-focal-length cameras, due to changes in various environmental factors (such as temperature, vacuum, etc.) or changes in the camera's own state, it is necessary to adjust the focal plane position according to actual conditions to ensure that the camera's imaging is at the optimal focal plane position. Currently, the methods for focusing long-focal-length cameras mainly include mechanical focusing, piezoelectric ceramic focusing, lens surface shape adjustment, and temperature-based focusing.

In the typical temperature-based focusing method, long-focal-length cameras generally utilize materials with large temperature coefficients to construct the support structures for different lenses (such as the primary and secondary lenses). These support structures are equipped with temperature control measures, which regulate the temperature of the structures, causing them to deform and alter the spacing between the lenses, thereby achieving the purpose of focusing. This method offers a certain level of precision but has a relatively small focusing range. However, the existing supporting structure has a large volume and makes the temperature control power relatively large.

### SUMMARY OF THE INVENTION

An objective of the present disclosure is to address the deficiency that the existing supporting structure has a large volume and makes the temperature control power relatively large in the prior art, and to provide a structure and method for temperature-based focusing of a long-focal-length camera.

To achieve the above objective, the technical solution provided by the present disclosure is as follows:

A structure for temperature-based focusing of a long-focal-length camera, including: a thermal ring, a thermal insulation pad, a secondary lens mount outer frame, and a primary lens support, which are coaxially arranged in sequence; an outer side face of the thermal ring is provided with a temperature control device and a temperature measuring device for controlling the temperature of the thermal ring; a secondary lens piece is arranged at the central axis of one end of the secondary lens mount outer frame far away from the thermal insulation pad, a plurality of secondary lens mount spokes are uniformly arranged on the secondary lens piece along the circumferential direction, one end of the secondary lens mount spoke far away from the secondary lens piece is fixedly connected with the secondary lens mount outer frame; the secondary lens piece is a convex lens, a convex surface facing the side of the secondary lens mount outer frame far away from the thermal insulation pad; one end of the secondary lens mount outer frame is rigidly connected to the primary lens support, the other end is rigidly connected to the thermal ring through the thermal insulation pad, and the other end of the secondary lens mount outer frame is driven to radially expand or contract by thermal expansion and contraction of the thermal ring along the radial direction, so that the secondary lens mount spokes drive the secondary lens piece to move along the axis thereof; and one end of the primary lens support far away from the secondary lens mount outer frame is provided with a primary lens piece, the primary lens piece is a concave lens, a concave surface facing the direction of the secondary lens piece, and the primary lens piece is provided with a through hole at the central axis thereof.

Further, the secondary lens mount spokes are flat spokes, the wide edges of the flat spokes are arranged in the same direction as the height of the secondary lens mount outer frame, one end face of the flat spoke is connected to the secondary lens mount outer frame, and the other end of the flat spoke is connected to the secondary lens piece at a corner near the primary lens piece. Further, the width of the flat spoke is the same as the height of the secondary lens mount outer frame.

Further, the other end of the secondary lens mount outer frame, the thermal insulation pad and the thermal ring are fixed by a plurality of bolts made of high thermal resistance materials. Further, the temperature control device employs heating fins which are uniformly disposed along the circumferential direction of the thermal ring, facilitating a uniform change in the temperature of the thermal ring.

Further, the thermal insulation pad, the secondary lens mount outer frame, the primary lens support, the secondary lens piece and the primary lens piece are all provided with temperature regulation devices.

Further, an end of the secondary lens mount outer frame close to the primary lens support and the primary lens support are fixedly connected by a force bearing barrel; the material of the thermal ring is red copper or aluminium alloy.

Meanwhile, the disclosure further provides a method for temperature-based focusing of a long-focal-length camera, based on the structure for temperature-based focusing of the long-focal-length camera, including: measuring the temperature of the thermal ring by the temperature measuring device, and controlling the temperature control device to adjust the temperature of the thermal ring according to a corresponding relationship between the temperature of the thermal ring and the amount of movement of a focal plane position, so that the thermal ring thermally expands and contracts along the radial direction and drives one end of the secondary lens mount outer frame to expand or contract, thereby moving and adjusting the position of the secondary lens piece to an optimal focal plane position.

Further, the corresponding relationship of the temperature of the thermal ring (1) and the amount of movement of the focal plane position is obtained by calibration, and the calibration steps are as follows:
S1, when the temperature of the thermal ring coincides with the temperature of the secondary lens mount outer frame, adjusting the camera to the optimal focal plane position and setting the current focal plane position to a zero position; and
S2, adjusting the temperature of the thermal ring according to the step size of 1° C. sequentially from the lowest temperature to the highest temperature in an operating temperature interval of the thermal ring, and recording the optimal focal plane position situation of the camera at each temperature state of the thermal ring, thereby establishing the corresponding relationship between the temperature of the thermal ring and the amount of movement of the focal plane position.

Compared with the prior art, the present disclosure has the following beneficial effects:
1. The present disclosure provides a thermal ring at one end of the secondary lens mount outer frame, which is rigidly connected to the thermal ring, while the other end of the secondary lens mount outer frame is rigidly connected to the primary lens support. By adjusting the temperature of the thermal ring, it expands or contracts radially, driving one end of the secondary lens mount outer frame to expand or contract correspondingly. The secondary lens mount spokes then change the position of the secondary lens piece, thereby changing the distance between the secondary lens piece and the primary lens piece, and achieving temperature-based focusing with a simple structure. This disclosure requires only temperature control of the thermal ring, utilizing a low-power temperature control device that responds quickly with minimal impact on other parts of the camera. The thermal insulation pad prevents the temperature of the thermal ring from affecting the secondary lens mount outer frame and causing it to deform due to heat.
2. In this disclosure, the secondary lens mount spokes are connected at their two ends respectively to the secondary lens mount outer frame and the secondary lens piece. When the end of the secondary lens mount outer frame near the thermal ring undergoes a small distance movement due to contraction or expansion, the length of the secondary lens mount spokes acts as a magnifier for this movement distance, resulting in an increased movement distance of the secondary lens piece relative to the movement distance of the secondary lens mount outer frame. Therefore, by utilizing the relatively small amount of deformation generated by the thermal ring, a larger movement amount of the secondary lens piece can be achieved, satisfying the focusing requirements of cameras with extremely small focusing structures. This allows for a wider range of temperature-based focusing to be realized within limited spaces.
3. In this disclosure, the secondary lens mount spokes adopt flat spokes, with their wide edges arranged in the same direction as the height of the secondary lens mount outer frame. This ensures that when the thermal ring contracts, the secondary lens piece moves closer to the primary lens piece, and when the thermal ring expands, the secondary lens piece moves away from the primary lens piece. The width of the flat spoke is the same as the height of the secondary lens mount outer frame, providing a more stable connection.
4. During the focusing process of this disclosure, the amount of movement of the thermal ring and the secondary lens mount outer frame is relatively small. Moreover, the contraction and expansion of the secondary lens mount outer frame are elastic deformations with good recovery, ensuring that the overall device performance remains stable over the long term. After initial calibration, the device ensures good repeatability in later use.
5. This disclosure utilizes electrical heating for focusing, providing convenient process control. The temperature control device used is relatively low-powered, making it well-suited for space-constrained cameras. The device is highly versatile and can be adjusted to accommodate different size requirements, resulting in lower costs.

### BRIEF DESCRIPTION OF DRAWINGS

FIG. 1 is a structural schematic diagram of an optical lens of a camera in an embodiment of the present disclosure;

FIG. 2 is a schematic diagram of an optical path of an optical lens of a camera in an embodiment of the present disclosure; and

FIG. 3 is a schematic diagram showing the operation principle of a thermal ring and a secondary lens mount outer frame in an embodiment of the present disclosure.

### DESCRIPTION OF REFERENCE NUMERALS

1-thermal ring, 2-thermal insulation pad, 3-secondary lens mount outer frame, 4-primary lens support, 5-secondary lens mount spoke, 6-secondary lens piece, 7-primary lens piece.

### DETAILED DESCRIPTION OF THE INVENTION

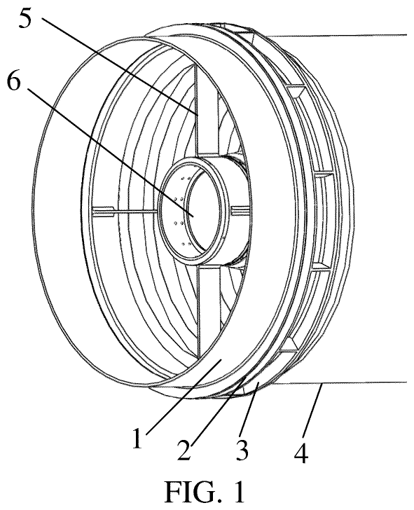

The structure for temperature-based focusing of the long-focal-length camera of the present disclosure, as shown in FIGS. 1 to 3, includes a thermal ring 1, a thermal insulation pad 2, a secondary lens mount outer frame 3, and a primary lens support 4, which are coaxially arranged in sequence. An outer side face of the thermal ring 1 is provided with a temperature control device and a temperature measuring device for controlling the temperature of the thermal ring 1. A secondary lens piece 6 is arranged at the central axis of one end of the secondary lens mount outer frame 3 far away from the thermal insulation pad 2, and four secondary lens mount spokes 5 are uniformly arranged on the secondary lens piece 6 along the circumferential direction. The secondary lens mount spokes 5 are flat spokes. The width of the flat spoke is the same as the height of the secondary lens mount outer frame 3. The wide edges of the flat spokes are arranged in the same direction as the height of the secondary lens mount outer frame 3, one end face of the flat spoke is connected to the secondary lens mount outer frame 3, and the other end of the flat spoke is connected to the secondary lens piece 6 at a corner near the primary lens piece 7. The secondary lens piece 6 is a convex lens, a convex surface facing the side of the secondary lens mount outer frame 3 far away from the thermal insulation pad 2. One end of the primary lens support 4 far away from the secondary lens mount outer frame 3 is provided with a primary lens piece 7, the primary lens piece 7 is a concave lens, a concave surface facing the direction of the secondary lens piece 6, and the primary lens piece 7 is provided with a through hole at the central axis thereof. An end of the secondary lens mount outer frame 3 close to the primary lens support 4 and the primary lens support 4 are fixedly connected by a force bearing barrel. The other end of the secondary lens mount outer frame 3, the thermal insulation pad 2 and the thermal ring 1 are fixed by a plurality of bolts made of high thermal resistance materials to ensure a rigid connection. The thermal insulation pad 2, the secondary lens mount outer frame 3, the primary lens support 4, the secondary lens piece 6 and the primary lens piece 7 are all provided with temperature regulation devices.

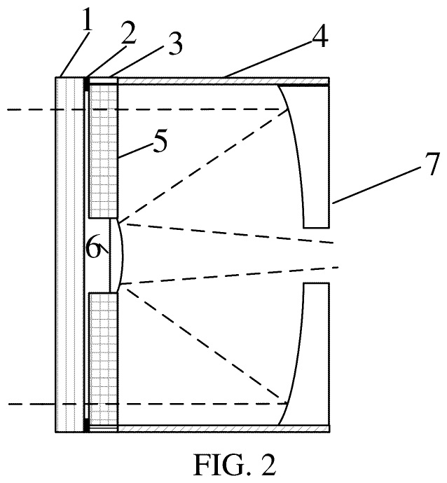

During use, the optical path is reflected around the primary lens piece 7 to the secondary lens piece 6, and then reflected by the secondary lens piece 6 to pass through the through hole of the primary lens piece 7, as shown by the dotted lines in FIG. 2.

In practical applications, precise temperature control is implemented on the thermal insulation pad 2, the secondary lens mount outer frame 3, the primary lens support 4, the secondary lens piece 6, and the primary lens piece 7 to ensure that their temperatures remain constant during operation, thereby ensuring the stability of the entire optical system. The secondary lens mount outer frame 3 and the secondary lens mount spokes 5 are made of materials with low thermal expansion coefficients to prevent deformation of the secondary lens mount due to changes in external thermal environments. At the same time, the thermal insulation pad 2 is installed between the secondary lens mount outer frame 3 and the thermal ring 1 to prevent temperature changes on the thermal ring 1 from affecting the secondary lens mount outer frame 3. The thermal ring 1 is made of materials with high thermal expansion coefficients and low specific heat capacities to improve the sensitivity and response speed of temperature control.

In this embodiment, the preferred material is red copper or aluminum alloy. The temperature adjustment range of the temperature control device installed on the thermal ring 1 can reach within ±10° C. of the temperature of the secondary lens mount outer frame 3, with a temperature adjustment accuracy of ±0.5° C. The temperature of the secondary lens mount outer frame 3 is usually ±2° C.

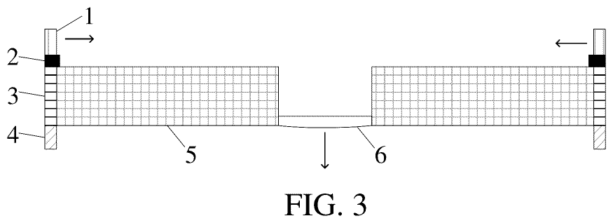

The principle of temperature-based focusing adjustment in this disclosure is as follows: when the temperature of the thermal ring 1 is reduced through the temperature control device, the thermal ring 1 contracts radially, as shown in FIG. 3. Since the thermal ring 1 is fixedly connected to the upper end of the secondary lens mount outer frame 3 through bolts, the contraction of the thermal ring 1 causes the upper end of the secondary lens mount outer frame 3 to contract as well. The lower end of the secondary lens mount outer frame 3 is fixedly connected to the primary lens support 4 through the force bearing barrel, and the temperature of the primary lens support 4 remains unchanged, so its structure does not deform, restricting the position of the lower end of the secondary lens mount outer frame 3. Therefore, when the thermal ring 1 contracts radially, the upper end of the secondary lens mount outer frame 3 contracts and generates a force directed towards the lower end, causing the secondary lens piece 6 to move downwards under the guidance of the secondary lens mount spokes 5, and reducing the distance between the secondary lens piece 6 and the primary lens piece 7. Conversely, when the temperature of the thermal ring 1 is increased through the temperature control device, the distance between the secondary lens piece 6 and the primary lens piece 7 increases, achieving the purpose of adjusting the focal plane position.

During the focusing adjustment process, although the thermal deformation amount of the thermal ring 1 itself is limited, the secondary lens mount spokes 5 have a certain length and serve as an amplification mechanism, ensuring that the displacement of the secondary lens piece 6 falls within a specific range that meets the operational requirements.

Since the deformation amount of the thermal ring 1 cannot be quantified, the camera requires temperature-based focusing calibration before use to determine the focal plane position of the camera at each temperature state. During normal operation of the camera in the later stage, the focal plane position can be determined based on the temperature measurements on the thermal ring 1. The calibration process of this disclosure includes the following steps:
S1, when the temperature of the thermal ring coincides with the temperature of the secondary lens mount outer frame, the camera is adjusted to the optimal focal plane position and the current focal plane position is set to a zero position; and
S2, the temperature of the thermal ring is adjusted according to the step size of 1° C. sequentially from the lowest temperature to the highest temperature in the operating temperature interval of the thermal ring, and the optimal focal plane position situation of the camera at each temperature state of the thermal ring is recorded, thereby establishing the corresponding relationship between the temperature of the thermal ring and the amount of movement of the focal plane position (μm/° C.).

During operation, if the camera becomes defocused due to certain factors while in orbit, the temperature of the thermal ring can be adjusted based on the above-mentioned calibration results that correlate the temperature of the thermal ring with the amount of movement of the focal plane position, in order to return the camera to its optimal focal plane position.

1. A structure for temperature-based focusing of a long-focal-length camera, comprising:
a thermal ring (1), a thermal insulation pad (2), a secondary lens mount outer frame (3), and a primary lens support (4), which are coaxially arranged in sequence;
an outer side face of the thermal ring (1) is provided with a temperature control device and a temperature measuring device for controlling the temperature of the thermal ring (1);
a secondary lens piece (6) is arranged at the central axis of one end of the secondary lens mount outer frame (3) far away from the thermal insulation pad (2), a plurality of secondary lens mount spokes (5) are uniformly arranged on the secondary lens piece (6) along the circumferential direction, one end of the secondary lens mount spoke (5) far away from the secondary lens piece (6) is fixedly connected with the secondary lens mount outer frame (3); the secondary lens piece (6) is a convex lens, a convex surface facing the side of the secondary lens mount outer frame (3) far away from the thermal insulation pad (2);
one end of the secondary lens mount outer frame (3) is rigidly connected to the primary lens support (4), the other end is rigidly connected to the thermal ring (1) through the thermal insulation pad (2), and the other end of the secondary lens mount outer frame (3) is driven to radially expand or contract by thermal expansion and contraction of the thermal ring (1) along the radial direction, so that the secondary lens mount spokes (5) drive the secondary lens piece (6) to move along the axis thereof; and
one end of the primary lens support (4) far away from the secondary lens mount outer frame (3) is provided with a primary lens piece (7), the primary lens piece (7) is a concave lens, a concave surface facing the direction of the secondary lens piece (6), and the primary lens piece (7) is provided with a through hole at the central axis thereof.

2. The structure for temperature-based focusing of a long-focal-length camera according to claim 1, wherein
the secondary lens mount spokes (5) are flat spokes, wide edges of the flat spokes are arranged in the same direction as the height of the secondary lens mount outer frame (3), one end face of the flat spoke is connected to the secondary lens mount outer frame (3), and the other end of the flat spoke is connected to the secondary lens piece (6) at a corner near the primary lens piece (7).

3. The structure for temperature-based focusing of a long-focal-length camera according to claim 2, wherein
the width of the flat spoke is the same as the height of the secondary lens mount outer frame (3).

4. The structure for temperature-based focusing of a long-focal-length camera according to claim 1, wherein
the other end of the secondary lens mount outer frame (3), the thermal insulation pad (2) and the thermal ring (1) are fixed by a plurality of bolts made of high thermal resistance materials.

5. The structure for temperature-based focusing of a long-focal-length camera according to claim 4, wherein
the temperature control device employs heating fins which are uniformly disposed along the circumferential direction of the thermal ring (1).

6. The structure for temperature-based focusing of a long-focal-length camera according to claim 5, wherein
the thermal insulation pad (2), the secondary lens mount outer frame (3), the primary lens support (4), the secondary lens piece (6) and the primary lens piece (7) are all provided with temperature regulation devices.

7. The structure for temperature-based focusing of a long-focal-length camera according to claim 6, wherein
an end of the secondary lens mount outer frame (3) close to the primary lens support (4) and the primary lens support (4) are fixedly connected by a force bearing barrel; the material of the thermal ring (1) is red copper or aluminium alloy.

8. A method for temperature-based focusing of a long-focal-length camera,
based on the structure for temperature-based focusing of the long-focal-length camera according to claim 1, comprising:
measuring the temperature of the thermal ring (1) by the temperature measuring device, and controlling the temperature control device to adjust the temperature of the thermal ring (1) according to a corresponding relationship between the temperature of the thermal ring (1) and the amount of movement of a focal plane position, so that the thermal ring (1) thermally expands and contracts along the radial direction and drives one end of the secondary lens mount outer frame (3) to expand or contract, thereby moving and adjusting the position of the secondary lens piece (6) to an optimal focal plane position.

9. The method for temperature-based focusing of a long-focal-length camera according to claim 8, wherein:
the corresponding relationship of the temperature of the thermal ring (1) and the amount of movement of the focal plane position is obtained by calibration, and the calibration steps are as follows:
S1, when the temperature of the thermal ring (1) coincides with the temperature of the secondary lens mount outer frame (3), adjusting the camera to the optimal focal plane position and setting the current focal plane position to a zero position; and
S2, adjusting the temperature of the thermal ring (1) according to the step size of 1° C. sequentially from the lowest temperature to the highest temperature in an operating temperature interval of the thermal ring (1), and recording the optimal focal plane position situation of the camera at each temperature state of the thermal ring (1), thereby establishing the corresponding relationship between the temperature of the thermal ring (1) and the amount of movement of the focal plane position.
